(19) United States
(12) Patent Application Publication
(10) Pub. No.: US 2024/0315199 A1
(43) Pub. Date: Sep. 26, 2024

(54) PET TAG

(71) Applicant: DAIZHUN DA, Shaoyang (CN)

(72) Inventor: DAIZHUN DA, Shaoyang (CN)

(21) Appl. No.: 18/188,561

(22) Filed: Mar. 23, 2023

(51) Int. Cl. A01K 11/00; G09F 3/02

(52) U.S. Cl. CPC A01K 11/00; G09F 3/0288; G09F 2003/0258

(57) ABSTRACT

The invention discloses a novel pet tag, in particular to the technical field of pet tags, comprising a main body, wherein the main body described comprises a transparent cover and a bottom shell; The inner side of the transparent cover is described provided with a plurality of mounting grooves I, and magnetic attractors I are arranged in the mounting grooves I described; The surface of the bottom shell described is also provided with a plurality of mounting grooves II at positions corresponding to the plurality of mounting grooves I on the transparent cover described.

### TECHNICAL FIELD

The invention relates to the technical field of pet tags, and more specifically, the invention relates to a novel pet tag.

### BACKGROUND

The most common pets are cats and dogs, which are also animals of human family. They widely exist in people's lives and work. In order to identify the identity of pets and contact their owners in time after they are lost, people usually wear tags on their chests.

However, the existing pet tag basically needs to be customized. For example, when you buy a tag in an online store or a physical store, you usually need to engrave/print the pet's name and the owner's phone number on the pet tag by laser engraving or printing, which leads to a long production time, and cannot achieve mass production and inventory, and the production cost is high, which is not conducive to market sales.

### SUMMARY

In order to overcome the defects of the prior art, an embodiment of the invention provides a novel pet tag to solve the problems raised in the background art.

In order to achieve the above purpose, the present invention provides the following technical scheme: A novel pet tag comprises a main body, wherein the main body described comprises a transparent cover and a bottom shell; The inner side of the transparent cover described is provided with a plurality of mounting grooves I, and magnetic attractors I are arranged in the mounting grooves I described;

The surface of the bottom shell described is also provided with a plurality of mounting grooves II at positions corresponding to the plurality of mounting grooves I on the transparent cover described, and a magnetic attraction II is arranged in the mounting grooves II described;

A plurality of groups of grooves are arranged on the surface of the bottom shell described, and matched metal seats are installed in the grooves;

An identification sticker is arranged above the metal seat described;

The identification sticker described is a magnetic sticker;

The transparent cover described is fixed on the bottom shell through mutual attraction of the magnetic attraction body I and the magnetic attraction body II.

Preferably, the identification sticker described is provided with a plurality of groups.

Preferably, telephone numbers and numbers are printed on the identification sticker described.

Preferably, English letters can also be printed on the identification sticker described.

Preferably, the identification sticker described is matched with the metal seat and fixed by magnetic attraction.

Preferably, the identification sticker described can also be arranged as a sticker with a back adhesive, which can be directly adhered to the fixed metal seat through the back adhesive.

Preferably, one side of the transparent cover and the bottom shell on the main body described is provided with a hanging ear.

Preferably, the transparent cover and the bottom shell described can also be fixed with each other by screws and/or buckles.

The invention has the technical effects and advantages that:

According to the invention, a plurality of magnetic attractors I and II are arranged on the transparent cover and the bottom shell, so that the rapid assembly of products is completed. Moreover, it is equipped with a plurality of magnetic identification stickers with different numbers and different English, which are fitted and fixed with the metal seat. Users can install the identification stickers corresponding to their pets' actual names and owners' telephone numbers on the metal seat, which is convenient and simple to use. In the later period, they can also change the pet names and owners' telephone numbers on the tag at any time, which is very practical, and can be mass-produced and stocked, and is suitable for vigorous promotion.

### BRIEF DESCRIPTION OF DRAWINGS

FIG. 1 is a schematic diagram of the overall structure of the present invention.

FIG. 2 is a schematic structural diagram of magnetic attraction I, magnetic attraction II, installation slot I and installation slot II in the present invention.

FIG. 3 is an overall sectional view of the present invention.

FIG. 4 is a schematic structural diagram of the label in the present invention.

FIG. 5 is a schematic structural diagram of the label, the metal base and the bottom shell in the present invention.

The reference number is: 1 main body, 2 magnetic attractors I, 3 magnetic attractors II, 4 metal seats, 5 label stickers, 6 hanging ears, 11 transparent cover, 12 bottom shell, 111 installation slots I and 121 installation slots II.

### DETAILED DESCRIPTION

In the following, the technical scheme in the embodiment of the invention will be clearly and completely described with reference to the attached drawings. Obviously, the described embodiment is only a part of the embodiment of the invention, but not the whole embodiment. Based on the embodiments in the present invention, all other embodiments obtained by ordinary technicians in the field without creative labor belong to the scope of protection of the present invention.

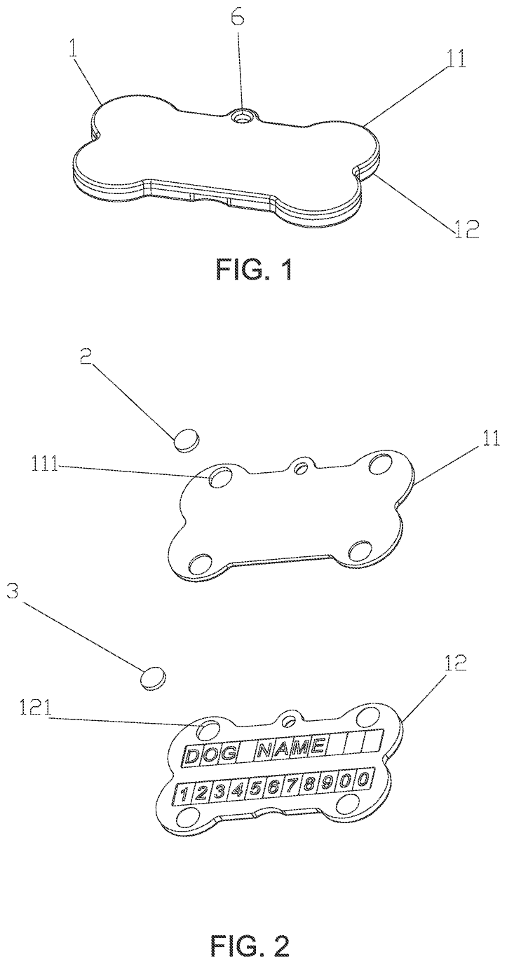

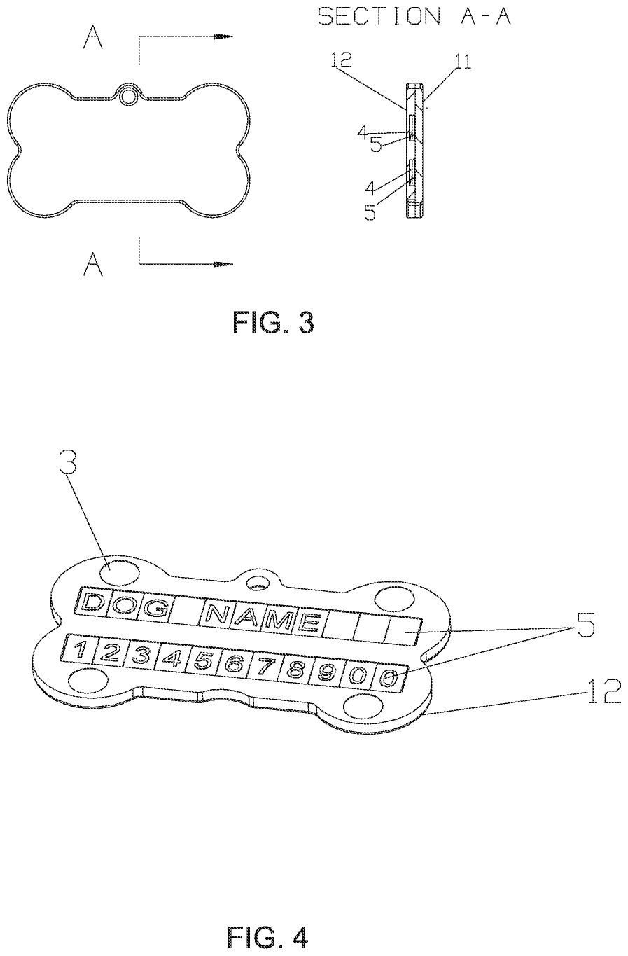

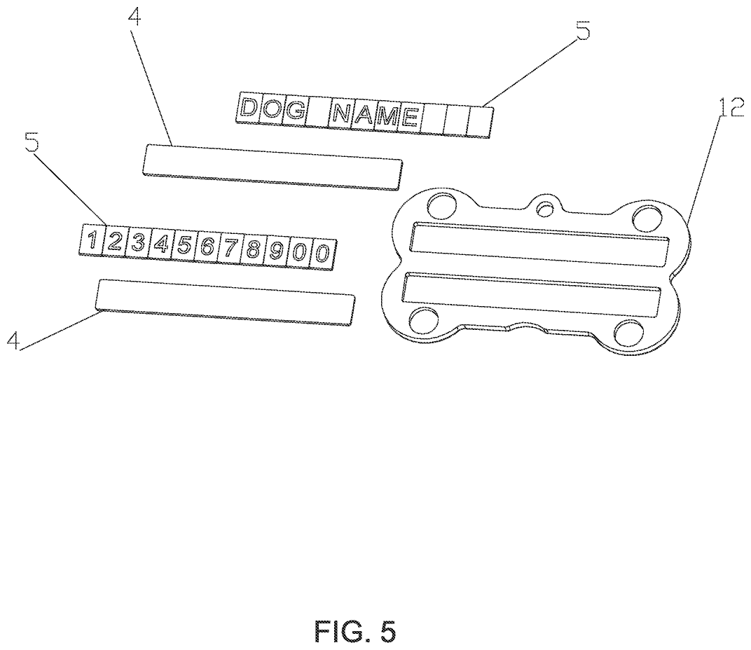

As shown in FIG. 1-FIG. 5, a novel pet tag comprises a main body 1, a transparent cover 11, an installation slot I 111, a bottom shell 12, an installation slot II 121, a magnetic attraction I 2, a magnetic attraction II 3, a metal seat 4, a label sticker 5 and a hanging ear 6, wherein the main body 1 comprises the transparent cover 11 and the bottom shell 12;

The inner surface of the transparent cover 11 described is provided with a plurality of mounting grooves I 111 described, and a magnetic attraction I 2 is arranged in the mounting grooves I 111.

The surface of the bottom case 12 described is also provided with a plurality of installation grooves II 121 at positions corresponding to the installation grooves I 111 on the transparent cover 11, and a magnetic attraction II 3 is arranged in the installation grooves II 121 described;

A plurality of groups of grooves are arranged on the surface of the bottom shell 12 described, and matched metal seats 4 are installed in the grooves;

An identification sticker 5 is arranged above the metal seat 4 described;

The identification sticker 5 described is a magnetic sticker;

The transparent cover 11 described is fixed on the bottom case 12 by mutual attraction between the magnetic attraction I 2 and the magnetic attraction II 3.

In some embodiments, there are multiple groups of identification stickers 5.

Further, telephone numbers and numbers are printed on the identification sticker 5.

Furthermore, English letters can be printed on the identification sticker 5.

Further, the identification sticker 5 is matched with the metal seat 4 and fixed by magnetic attraction.

Further, the identification sticker 5 can also be arranged as a sticker with a back adhesive, which can be directly adhered to the metal seat 4 through the back adhesive.

Furthermore, one side of the transparent cover 11 and the bottom shell 12 on the main body 1 described is provided with a hanging ear 6.

Specifically, the transparent cover 11 described and the bottom case 12 can be fixed to each other by screws and/or buckles.

The work principle of that invention is as follows:

The invention is mainly composed of a transparent cover 11, a bottom shell 12 and a metal seat 4. The transparent cover 11 and the bottom shell 12 are both provided with a magnetic attraction I 2 and a magnetic attraction II 3. Wherein, the magnetic attractor I 2 is the S pole/N pole of the magnet, and the magnetic attractor II 3 is the N pole/S pole which is matched. Based on the principle of attracting different poles of the magnet, the transparent cover 11 and the bottom case 12 are mutually attracted and fixed by a plurality of corresponding magnetic attractors with different polarities. When the product leaves the factory, it has been equipped with multiple groups of telephone numbers and numbers (such as 0-9 as a group) and multiple groups of English letters (such as 26 English letters as a group). And the different numbers and English letters in each group of identification stickers 5 are separate individuals, and when in use, they only need to be assembled and installed on the metal seat 4 on the bottom shell 12 according to the actual pet name and the owner's telephone number. The magnetic identification sticker 5 is matched with the metal seat 4 and fixed by magnetic attraction, thus completing the whole installation. Finally, it is hung in the hanging ear 6 on the main body 1 through a hanging rope and/or chain, and hung at the neck of the pet. If the pet is lost, people who find it can check the pet name and the owner's phone number through the transparent cover 11, and can contact the pet owner in time.

It should be noted that the identification sticker 5 can also be set as a sticker with adhesive, which can be directly adhered to the metal base 4 and/or the bottom shell 12 when in use. Moreover, the transparent cover 11 and the bottom case 12 can be fixed with screws or with buckles.

Finally, the following points should be explained: First of all, in the description of this application, it should be noted that, unless otherwise specified and limited, the terms “installation”, “attach” and “connection” should be broadly understood, which can be mechanical or electrical connection, internal connection of two elements, or direct connection, and the terms “up”, “down”, “left” and “right” are only used to indicate the relative positional relationship.

Secondly: In the drawings of the disclosed embodiment of the present invention, only the structure related to the disclosed embodiment is involved, and other structures can refer to the usual design, and the same embodiment and different embodiments of the present invention can be combined with each other without conflict;

Finally: The above is only the preferred embodiment of the invention, and it is not used to limit the invention. Any modification, equivalent substitution, improvement, etc. made within the spirit and principle of the invention should be included in the protection scope of the invention.

What is claimed is:

1. A novel pet tag comprises a main body (1), and is characterized in that: The main body (1) comprises a transparent cover (11) and a bottom shell (12); The inner side of the transparent cover (11) described is provided with a plurality of mounting grooves I (111), and magnetic attractors I (2) are arranged in the mounting grooves I (111) described;
The surface of the bottom shell (12) described is also provided with a plurality of mounting grooves II (121) at positions corresponding to the plurality of mounting grooves I (111) on the transparent cover (11) described, and a magnetic attraction II (3) is arranged in the mounting grooves II (121) described;
The surface of the bottom shell (12) described is provided with a plurality of groups of grooves, and matched metal seats (4) are installed in the grooves;
An identification sticker (5) is arranged above the metal seat (4) described;
The identification sticker (5) described is a magnetic sticker;
The transparent cover (11) described is fixed on the bottom shell (12) by mutual attraction of the magnetic attraction body I (2) and the magnetic attraction body II (3).

2. The novel pet tag described according to claim 1 is characterized in that: The identification sticker (5) is provided with a plurality of groups.

3. The novel pet tag described according to claim 1 is characterized in that: The identification sticker (5) is printed with telephone numbers.

4. The novel pet tag described according to claim 1 is characterized in that: English letters can also be printed on the identification sticker (5).

5. The novel pet tag described according to claim 1 is characterized in that: The identification sticker (5) is matched with the metal seat (4) and fixed by magnetic attraction.

6. The novel pet tag described according to claim 1 is characterized in that: The identification sticker (5) can also be arranged as a sticker with a back adhesive, and can be directly adhered and fixed on the metal seat (4) through the back adhesive.

7. The novel pet tag described according to claim 1 is characterized in that: One side of the transparent cover (11) and the bottom shell (12) on the main body (1) is provided with a hanging ear (6).

8. The novel pet tag described according to claim 1 is characterized in that: The transparent cover (11) and the bottom shell (12) can also be fixed with each other by screws and/or buckles.
